(19) United States
(12) Patent Application Publication
(10) Pub. No.: US 2018/0367511 A1
(43) Pub. Date: Dec. 20, 2018

(54) EMAIL CONTROL DEVICE, EMAIL CONTROL METHOD, AND PROGRAM STORAGE MEDIUM

(71) Applicant: NEC Corporation, Tokyo (JP)

(72) Inventor: Shinji CHICHIBU, Tokyo (JP)

(73) Assignee: NEC Corporation, Tokyo (JP)

(21) Appl. No.: 16/060,072

(22) PCT Filed: Dec. 19, 2016
(86) PCT No.: PCT/JP2016/087711

§ 371 Date: Jun. 7, 2018

(30) Foreign Application Priority Data
Dec. 24, 2015 (JP) 2015-251858

(51) Int. Cl. H04L 29/06; H04W 4/14

(52) U.S. Cl. CPC H04L 63/0428; H04W 4/14; H04L 63/1425; H04L 63/08

(57) ABSTRACT

In order to prevent damage caused by a scam that takes advantage of the function for updating an authorized user's personal information in an information system, this email control device 1 is provided with a detection unit 3, a suspension unit 4, and a confirmation unit 5. The detection unit 3 detects, as secret email, an email which contains authentication-related information concerning information that is transmitted from an information system to be protected, and that is used in an authentication process in the information system. The suspension unit 4 monitors transmitted email for a predetermined monitoring period following the detection of secret email, and upon detection of an email containing the authentication-related information, suspends transmission of the detected email. The confirmation unit 5 submits, to the transmission source of the suspended email, a message for confirming whether transmission of the suspended email is required.

### TECHNICAL FIELD

The present invention relates to a technique of communicating mail (a message) in a short message service (SMS).

### BACKGROUND ART

A short message service (SMS) is a service that allows short character messages (mail) to be transmitted and received between mobile phones, and mobile phone number is used as address of message (mail). Recently, a new phishing scam using a mail function of the SMS (a scam of stealing information from a user of the Internet (computer network)) has been confirmed. This scam is a scam related to an information system as follows. For example, the information system is a system in which a service cannot be used unless permission is made by an authentication process to determine permission or non-permission of use of a service, and mail based on the SMS is used for changing information such as a password to confirm whether it is an authorized user being used in the authentication process. Specific examples of the information system include a mail service system using an information communication network such as the Internet, and a system of a net banking service.

Note that information such as the password to confirm whether it is the authorized user being used in an authentication process (hereinafter such information is written also as identity information) has various types of information, but the following description is made by citing a password as identity information. In the present specification, mail based on the SMS is written also as SMS mail.

In the above-described scam using a function of changing the identity information (password) in the information system, it is premised that an attacker (offender of the scam) knows a unique identification (ID) and a mobile phone number of a user of the information system as a victim of the scam. The attacker illegally acquires (obtains) information of the user (victim) from the information system by the following scam conduct.

First, the attacker sends, to the information system, a password change request together with a unique ID (user ID) of the user (victim). The information system receiving this request transmits a confirmation code to the user by SMS mail using the mobile phone number registered in such a way as to be associated with the user ID. The confirmation code is for example six alphanumeric characters and is information necessary for changing the password.

Meanwhile, the attacker transmits, to the user (victim), a message requesting a reply of the confirmation code by SMS mail (written also as scam mail) using the mobile phone number of the user. For example, this message includes contents that cause impatience of the user and take away serenity, such as “Illegal access to your account has been detected. In order to stop this, please reply the confirmation code transmitted to the mobile phone”.

The attacker can obtain the confirmation code by the user (victim) receiving such scam mail and returning the mail to which the confirmation code is added. Then, by using the obtained confirmation code, the attacker can change a password of the user (victim), and thereby, is able to use a service of the information system with the changed password. Then, the attacker can acquire personal information and the like of the user, being registered in the information system.

It is considered that normally the user is wary and does not return a reply to the scam mail requesting a reply of the confirmation code. However, by transmitting the scam mail in such a way as to synchronize with a timing when the proper SMS mail from the information system is transmitted, the attacker causes the user to mistakenly understand that the scam mail is a proper notification from the information system, and loosens wariness of the user. Further, by creating a scam mail message of a text such as “Illegal access has been detected” representing necessity of an urgent countermeasure, the attacker induces impatience of the user and takes away serenity. Thereby, the user cannot make normal determination, and returns, to the scam mail, reply mail to which the confirmation code is added.

Note that PTL 1 relates to an email filter device. PTL 1 discloses a technique of analyzing character strings (sentences) included in email, thereby extracting character strings having no linguistic meaning, and determining appropriateness or inappropriateness of the email, based on a ratio of the extracted character strings to the entire sentences.

PTL 2 relates to a method of transmitting a short message. PTL2 discloses a configuration in which a sentence is read from received short mail, based on information of one or both of a structure and a content of a short message, and is displayed on a display device.

### CITATION LIST

### Patent Literature

[PTL 1] Japanese Unexamined Patent Application Publication No. 2009-230333

[PTL 2] Japanese Unexamined Patent Application Publication No. 2010-44774

### SUMMARY OF INVENTION

### Technical Problem

Incidentally, phishing scams include a type that uses a fake website (fake site) managed by an attacker. In this type of phishing scam, mail including a written uniform resource locator (URL) of the fake site is transmitted to a user. By the user accessing the fake site by using the URL of the mail and inputting a password and a user ID from the fake site, the attacker can obtain the user ID and password of the user (victim). The attacker can acquire personal information of the user and the like from an information system by using the obtained user ID and password.

Examples of a method for preventing such a phishing scam include a method of extracting, as unsolicited mail, mail including a written URL, and inducing caution in a user. However, the above-described scam (phishing scam) using a password change function (identity-information change function) of the information system has been just confirmed, and no effective countermeasure has been taken.

In order to solve the above-described problem, the present invention has been conceived. In other words, a main object of the present invention is to provide a technique of suppressing damage by a scam that uses a function of changing identity information on confirming an authorized user in an information system.

### Solution to Problem

To achieve the main object of the present invention, a mail control device recited in the present invention includes:

a detection unit that detects, as secret mail, mail that is sent from an information system to be protected, and includes authentication-related information related to information used in an authentication process of the information system;

a suspension unit monitors transmitted mail for a preset monitoring period from a time when the secret mail is detected, and, when detecting mail including the authentication-related information, suspends transmission of the detected mail; and

a confirmation unit presents, to a sender of a pending mail, a message to confirm whether it is necessary to transmit the pending mail, the pending mail is the mail suspended for transmission.

A mail control method recited in the present invention includes:

detecting, as secret mail, mail that is sent from an information system to be protected, and includes authentication-related information related to information used in an authentication process of the information system;

monitoring transmitted mail for a preset monitoring period from a time when the secret mail is detected, and, when detecting mail including the authentication-related information, suspending transmission of the detected mail; and

presenting, to a sender of a pending mail, a message to confirm whether it is necessary to transmit the pending mail, the pending mail being the mail suspended for transmission.

A program storage medium recited in the present invention which stores a computer program representing a control procedure causing a computer to perform:

detecting, as secret mail, mail that is sent from an information system to be protected, and includes authentication-related information related to information used in an authentication process of the information system;

monitoring transmitted mail for a preset monitoring period from a time when the secret mail is detected, and, when detecting mail including the authentication-related information, suspending transmission of the detected mail; and

presenting, to a sender of a pending mail, a message to confirm whether it is necessary to transmit the pending mail, the pending mail being the mail suspended for transmission.

Note that the above-described main object of the present invention may also be achieved by a mail control method according to the present invention corresponding to the mail control device according to the present invention. Further, the above-described main object of the present invention may also be achieved by a computer program corresponding to the mail control device and the mail control method according to the present invention, and by a program storage medium that stores the computer program.

### Advantageous Effects of Invention

According to the present invention, it is possible to suppress damage by a scam that uses a function of changing identity information on confirming an authorized user in an information system.

### BRIEF DESCRIPTION OF DRAWINGS

FIG. 1 is a block diagram illustrating a configuration of a mail control device of a first example embodiment according to the present invention.

FIG. 2 is a block diagram illustrating one example of a hardware configuration of the mail control device of the first example embodiment.

FIG. 3 is a diagram illustrating a configuration of a mail control device of a second example embodiment according to the present invention.

FIG. 4 is a sequence diagram illustrating a flow of a process for scam prevention, using the mail control device of the second example embodiment.

FIG. 5 is a sequence diagram illustrating a flow of a process in which a scam is accomplished.

FIG. 6 is a diagram illustrating a configuration of a mail control device of a third example embodiment according to the present invention.

FIG. 7 is a diagram illustrating a configuration of a mail control device of a fourth example embodiment according to the present invention.

### DESCRIPTION OF EMBODIMENTS

Hereinafter, example embodiments according to the present invention are described with reference to the drawings.

### First Example Embodiment

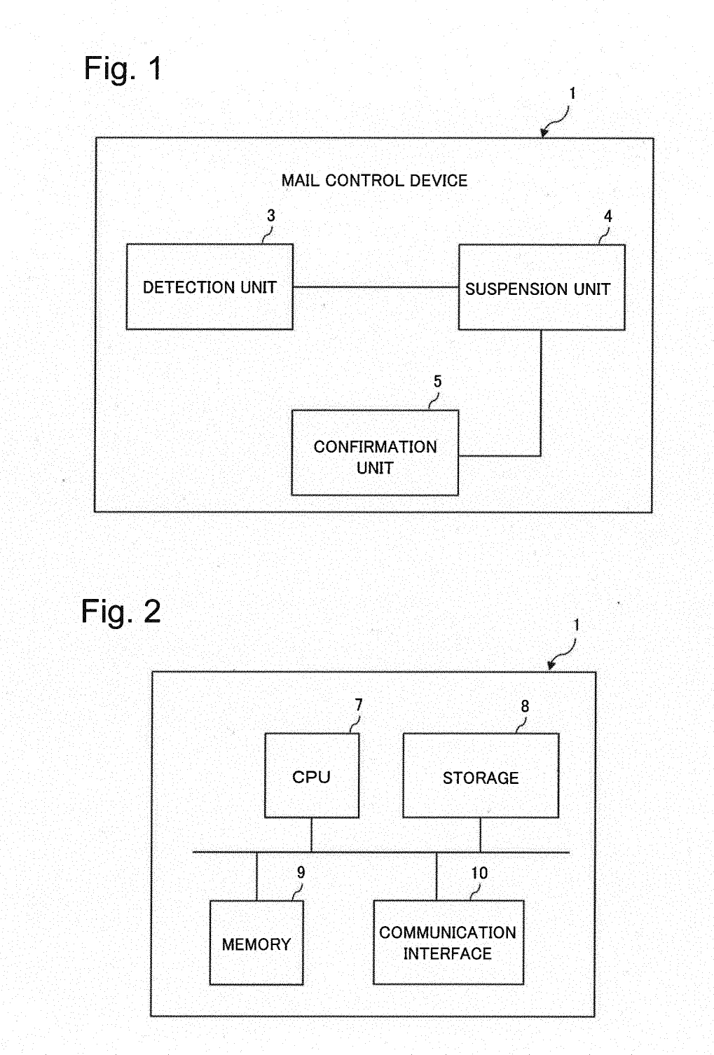

FIG. 1 is a block diagram illustrating a simplified configuration of a mail control device of a first example embodiment according to the present invention. The mail control device 1 of the first example embodiment includes, as functional units, a detection unit 3, a suspension unit 4, and a confirmation unit 5.

The detection unit 3 has a function of detecting, as secret mail, mail that is sent from an information system to be protected and that includes authentication-related information related to information used in an authentication process of the information system.

The suspension unit 4 has a function of monitoring transmitted mail in a preset monitoring period from the time that the secret mail is detected, and when detecting mail including the same authentication-related information as the authentication-related information in the secret mail, suspending the transmission of the detected mail.

The confirmation unit 5 has a function of presenting, to a sender of the pending mail, a message to confirm whether it is necessary to transmit the pending mail being mail under suspension.

The mail control device 1 of the first example embodiment can suspend mail including authentication-related information (information related to information used in an authentication process of the information system to be protected). Thus, even when mail including authentication-related information is sent carelessly by a user of the information system to be protected, the mail can be prevented from immediately reaching the destination.

Further, when the mail including authentication-related information is sent, the mail control device 1 presents a confirmation message to a user of being a sender who has sent the mail. Thereby, even when the user impatiently transmits the mail including the authentication-related information, the mail control device 1 can give the user an opportunity of reconsidering whether the mail needs to be transmitted, by the message. In other words, the mail control device 1 can prompt the user to make a cool determination on the necessity of transmitting the mail including the authentication-related information. Then, when the user determines cancellation of the transmission of the mail including the authentication-related information, the mail control device 1 cancels the transmission of the pending mail, for example, and thereby, can prevent a situation where the mail including the authentication-related information reaches an attacker. That is, the mail control device 1 can prevent scam conduct of the attacker due to acquisition of the authentication-related information. Therefore, the mail control device 1 can suppress damage by the scam that uses a function of changing registered-information of the information system.

Here, the description is made on one example of a hardware configuration when the mail control device 1 is implemented by a computer. FIG. 2 is a block diagram illustrating one example of a hardware configuration of the mail control device 1. The mail control device 1 illustrated in FIG. 2 includes a central processing unit (CPU) 7, a storage 8, a memory 9, and a communication Interface (IF) 10. These CPU 7, storage 8, memory 9, and communication IF 10 are connected to each other.

The memory 9 is a storage medium such as a random access memory (RAM). The memory 9 temporarily stores a computer program (hereinafter, abbreviated also to a program) executed by the CPU 7, and data required for execution of the program. The storage 8 is a nonvolatile storage medium such as a hard disk device and a flash memory, for example. The storage 8 stores various programs including the program for implementing the functional units such as the detection unit 3, the suspension unit 4, and the confirmation unit 5, and various data. Depending on necessity, the programs and data stored in the storage 8 are loaded in the memory 9 and thereby referred to by the CPU 7.

The CPU 7 implements various functions in the mail control device 1 by executing the program stored in the memory 9. In other words, the detection unit 3, the suspension unit 4, and the confirmation unit 5 are implemented by the CPU 7. The communication IF 10 is a device having a function of communicating data.

### Second Example Embodiment

Hereinafter, a second example embodiment according to the present invention is described.

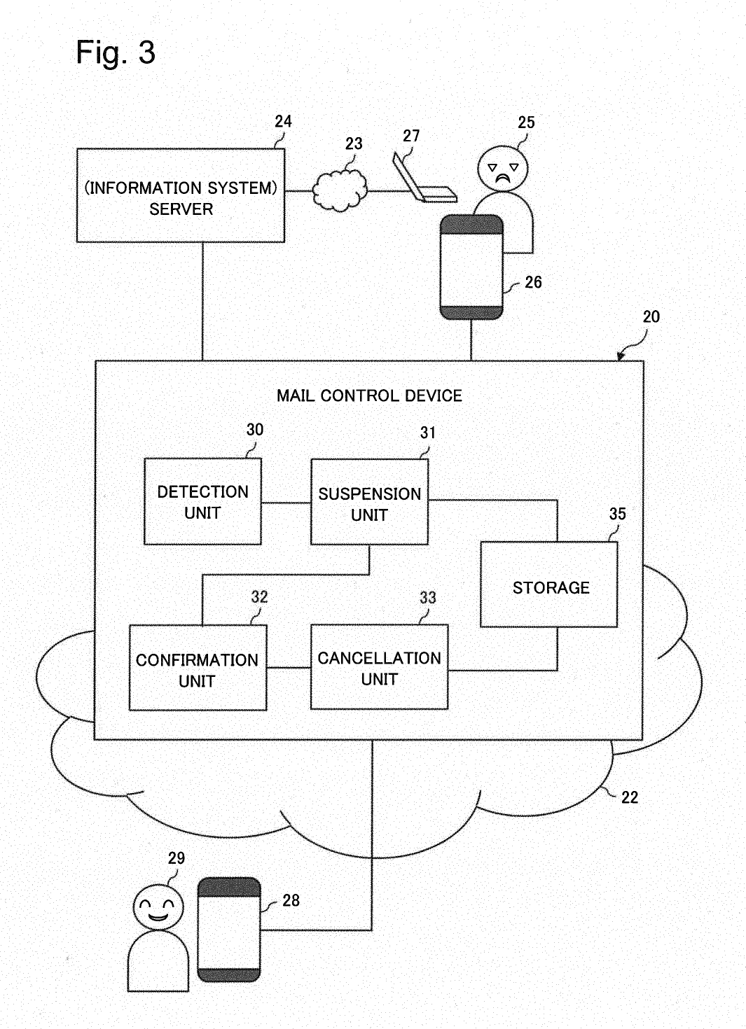

FIG. 3 is a block diagram illustrating a configuration of a mail control device of the second example embodiment according to the present invention. The mail control device 20 of the second example embodiment is a server interposed in a mobile phone communication network 22, and has a function of relaying mail using the mobile phone communication network 22. Here, the mail relayed by the mail control device 20 is mail (SMS mail) based on the short message service (SMS). For example, the mail control device 20 includes a hardware configuration as illustrated in FIG. 2, and has the following functions implemented by the CPU 7.

In other words, the mail control device 20 includes, as functional units, a detection unit 30, a suspension unit 31, a confirmation unit 32, and a cancellation unit 33. In addition, the mail control device 20 further includes a storage 35 implemented by the storage 8 and the memory 9 illustrated in FIG. 2. In other words, various programs and data are stored in the storage 35 (the storage 8 and the memory 9), and the CPU 7 executing the program stored in the storage 35 implements the respective functional units 30 to 33 in the mail control device 20.

The detection unit 30 has a function of detecting secret mail sent from the server 24 of the information system to be protected, among pieces of mail to be relayed (i.e., SMS mail). Here, the information system to be protected is a system in which an authentication process is required for use of a service provided by the system. Specific examples of the information system to be protected include a system that provides a mail service using an information communication network such as the Internet, a system (a net banking system) that provides a transaction service of a bank using an information communication network, and the like. In a server of such a system, for example, permission or non-permission of service use is determined by an authentication process (identity confirmation) using a unique ID (user ID), a password, and the like registered in advance by a user. Then, when the service use is permitted by the authentication process, the server starts to provide the service to the user. Such an authentication process is performed each time service provision is requested from a user.

In an information system performing an authentication process, there is often incorporated a setup of a relief measure for the case where a user forgets information (identity information for confirming an authorized user) such as a password used in the authentication process. One of the relief measures uses SMS mail. SMS mail is mail that uses the mobile phone number as an address. When the mobile phone number is acquired, identity of an owner of the mobile phone is confirmed, and thus, it is considered that identity of the owner of the mobile phone capable of receiving SMS mail including the mobile phone number as an address has been confirmed. Further, SMS mail can be received only by a terminal capable of using the mobile phone number, and reliability that SMS mail reaches a user as a destination can be enhanced compared with mail using an information communication network such as the Internet.

For the reason, when receiving from a user a notification informing that identity information (a password or the like) used in the authentication process have been forgotten, the server of the information system transmits authentication-related information to the user by SMS mail, for example. The authentication-related information in this case is a provisional password that proves the identity and that is necessary when the user who has forgotten the identity information used in the authentication process registers new identity information. In the present specification, the provisional password is written as a confirmation code. Further, SMS mail that is sent from the server of the information system to be protected and that includes authentication-related information (the confirmation code) is written as secret mail. Furthermore, a destination of the secret mail is the mobile phone number of the user registered in advance in the information system.

After transmitting the confirmation code, when receiving combination of the confirmation code, the user ID, and new identity information, the server of the information system determines whether the combination of the received confirmation code and user ID matches the registered information. Then, when determining that the matching is satisfied, i.e., the combination of the received confirmation code and user ID is correct, the server sets the received identity information as new updated identity information. After that, by using the new identity information, the user is permitted to use a service, by the authentication process of the information system.

The detection unit 30 detects that the above-described secret mail (SMS mail including the authentication-related information (confirmation code)) is sent to the user from the server 24 of the information system. Whether the sender of the SMS mail is the information system can be determined by confirming whether the mail is sent by short message peer-to-peer protocol (SMPP) communication, for example. Whether the confirmation code is included can be determined by the number of characters of the alphanumeric strings in a main body and a subject of the SMS mail, or by using a dictionary in which information of the confirmation code is registered in advance.

Note that the detection unit 30 may have a function of machine-learning the dictionary of confirmation codes by accumulating information of detected confirmation codes.

The suspension unit 31 has a function of selecting, from pieces of mail to be relayed, SMS mail of which sender is a destination of secret mail (i.e., the mobile phone number of the user of the information system), in a preset monitoring period from the time that the detection unit 30 detects the secret mail. Further, the suspension unit 31 has a function of monitoring (scanning) a subject and a main body of the selected SMS mail. Furthermore, the suspension unit 31 has a function of, when detecting SMS mail including authentication-related information (a confirmation code) by the monitoring, suspending the relaying of the SMS mail. The suspension unit 31 stores the pending mail in the storage 35.

The monitoring period in which the suspension unit 31 monitors SMS mail of which sender is a destination of the secret mail is set as several hours, for example. When this monitoring period is short, there is a possibility of the failure to detect SMS mail including the authentication-related information, and when the monitoring period is too long, a load of the mail control device 20 increases. By taking into consideration such a matter or a change-allowable period from the time that the server 24 of the information system receives a request of changing identity information (a password or the like) until a preset waiting time elapses, and the like, the monitoring period is appropriately set.

The confirmation unit 32 sends confirmation mail when the suspension unit 31 suspends the relaying of SMS mail. The confirmation mail is SMS mail of which destination is a sender of the suspended SMS mail, and is mail including a text by which the user who has sent the SMS mail including the confirmation code is prompted to reconfirm whether the mail needs to be transmitted. Specific examples of the text of the confirmation mail include “although the confirmation code is intended to be transmitted to a third party, are there really no problems? Do you allow the mail to be transmitted? Do you cancel the transmission? Please return your reply”.

The cancellation unit 33 has a function of, after the confirmation unit 32 transmits the confirmation mail, receiving reply mail as a response to the confirmation mail, and when the reply mail includes a request of cancelling the transmission of the mail (pending mail) under suspension, accepting the request. Specifically, when receiving the request of cancelling the transmission, the cancellation unit 33 deletes the pending mail of which transmission (relaying) is cancelled, from pieces of pending mail stored in the storage 35.

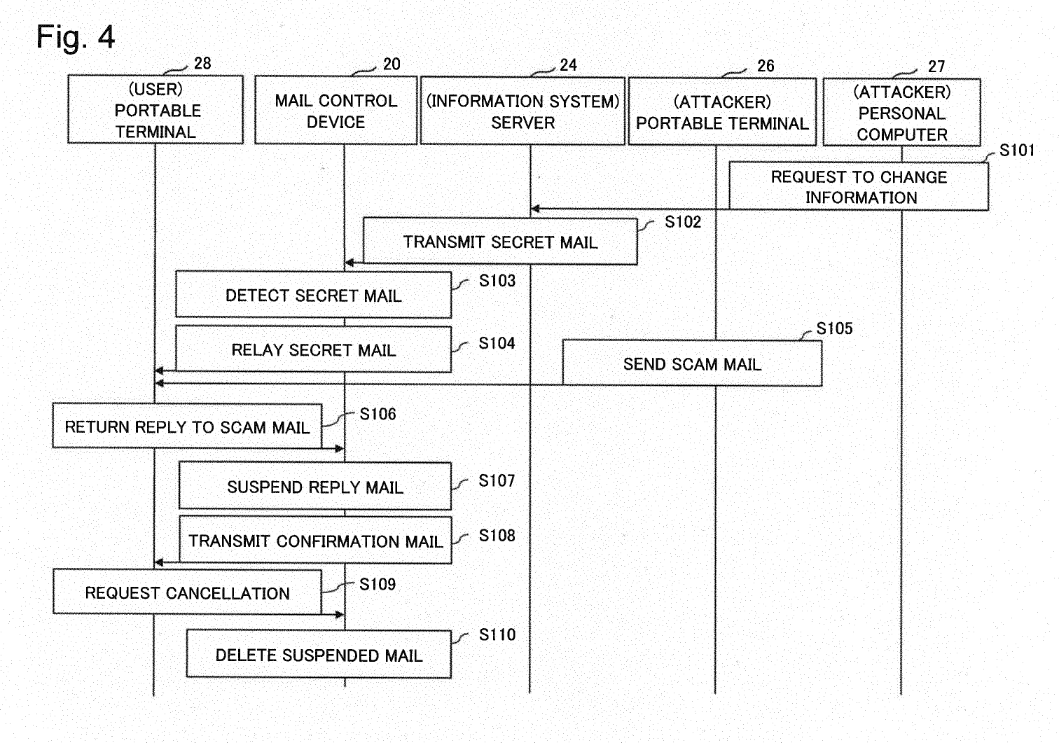

The mail control device 20 of the second example embodiment is configured as described above. Next, with reference to FIG. 4, the description is made on a flow of a process in which the mail control device 20 prevents a scam using the function of changing the identity-information (password-or-the-like) in the information system. FIG. 4 is a sequence diagram illustrating the process flow for preventing the scam. In the present description, a person who conducts the scam is written as an attacker 25 (see FIG. 3). It is assumed that the attacker 25 possesses a portable terminal 26 connectable to the mobile phone communication network 22, and a personal computer 27 connectable to an information communication network 23 such as the Internet. Further, in this case, the user ID and the password unique to each user are registered in the server 24 of the information system. Furthermore, it is assumed that in the server 24 of the information system, the mobile phone number of the user is registered in such a way as to be associated with the user ID. When starting to provide a service, the server 24 of the information system performs the authentication process based on combination of the user ID and the password (identity information), and thereby provides the service only to the permitted user 29.

First, it is assumed that the attacker 25 has acquired the user ID that is the identification information of the scam-target user 29 registered in the server 24 of the information system of being target for attack, and the mobile phone number of the portable terminal 28 possessed by the user 29. The attacker 25 operates the personal computer 27, and thereby, a request of changing the identity information (the password) of the user 29 is transmitted to the server 24 of the information system of being target for attack by using the user ID of the scam-target user 29 (step S101 in FIG. 4).

When receiving the request of changing the identity information associated with the user ID, the server 24 of the information system transmits the secret mail (i.e., mail including the confirmation code (the authentication-related information)) by using the mobile phone communication network 22 (step S102). In other words, the server 24 transmits the confirmation code by SMS mail of which destination is the mobile phone number of the portable terminal 28 of the user 29 allocated to the user ID associated with the request of changing the identity information.

The detection unit 30 of the mail control device 20 interposed in the mobile phone communication network 22 detects the secret mail by monitoring a main body and a subject of the SMS mail to be relayed (step S103). Further, the mail control device 20 transmits (relays) the secret mail to the destination (step S104).

When the detection unit 30 detects the secret mail, the suspension unit 31 starts to monitor mail of which sender is the destination of the secret mail (the mobile phone number of the portable terminal 28), until a preset monitoring period (e.g., several hours) elapses from the time that the detection unit 30 detects the secret mail. In other words, the suspension unit 31 selects, from pieces of mail to be relayed, the mail of which sender is the destination of the detected secret mail, scans the subject and the main body of the selected mail, and thereby determines whether the confirmation code is included.

Meanwhile, the attacker 25 uses the portable terminal 26 and sends scam mail (SMS mail) using the mobile phone communication network 22 to the portable terminal 28 possessed by the scam-target user 29 (step S105). For example, the scam mail is transmitted in such a way as to synchronize with the timing that the secret mail is transmitted from the server 24 of the information system. The text of the scam mail is a text that incites anxiety of the user 29, and includes contents informing a situation where it is preferable to immediately return the confirmation code described in the received secret email.

When, by operation of the user 29 who has read the scam mail, the portable terminal 28 transmits the mail including the confirmation code as reply mail responding to the scam mail (step S106), the suspension unit 31 of the mail control device 20 suspends the reply mail (step S107). Then, the confirmation unit 32 transmits the confirmation mail (SMS mail) to the sender (the portable terminal 28) of the pending mail (step S108).

The main body of the confirmation mail includes contents that intend the user 29 to become aware that the scam mail is mail based on the scam conduct, for example. Further, the main body of the confirmation mail includes contents informing that the reply mail including the confirmation code is under suspension, and that when it is desired to cancel the relaying (transmission) of the pending mail, it is required to return the mail including a cancellation request for the cancellation.

When, by operation of the user 29 who has read the confirmation mail, the portable terminal 28 returns the mail including the request of cancelling the relaying of the pending mail (step S109), the cancellation unit 33 that receives the mail deletes the pending mail to be cancelled (step S110).

Thus, the mail control device 20 can prevent the mail including the confirmation code can be prevented from reaching the portable terminal 26 of the attacker 25.

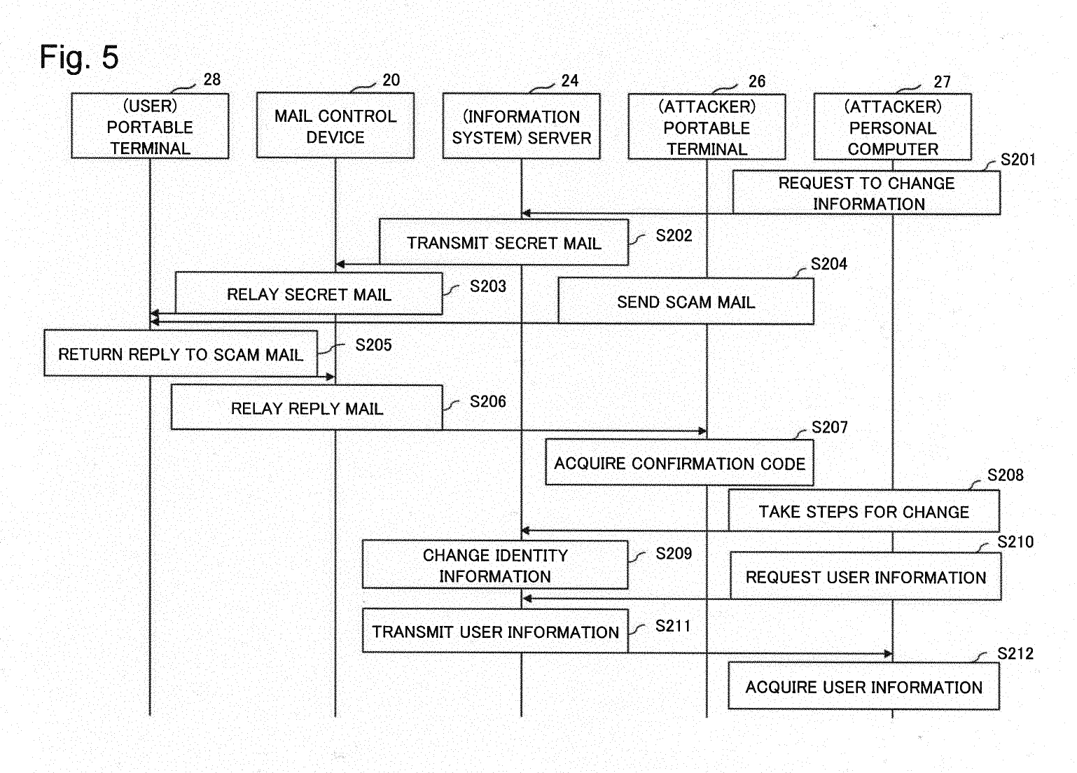

Here, a flow of a process when the mail control device 20 does not have the function of preventing the scam using the function of changing the identity-information in the information system is described with reference to a sequence diagram of FIG. 5.

First, the attacker 25 operates the personal computer 27, and thereby, the request of changing the identity information (the password) of the user 29 is transmitted to the server 24 of the information system of being target for attack by using the user ID of the scam-target user 29 (step S201 in FIG. 5). Thereby, the server 24 of the information system transmits secret mail (SMS mail) including the confirmation code (the authentication-related information) to the portable terminal 28 of the user 29 by using the mobile phone communication network 22 (step S202). The mail control device 20 in the mobile phone communication network 22 relays the secret mail (step S203).

Meanwhile, the attacker 25 uses the portable terminal 26 and sends the scam mail (SMS mail) using the mobile phone communication network 22 to the portable terminal 28 possessed by the scam-target user 29 (step S204). The scam mail is transmitted at an estimated transmission timing in such a way as to reach the portable terminal 28 in synchronization with the secret mail.

When, by operation of the user 29 as a response to the scam mail, the portable terminal 28 transmits the mail including the confirmation code as a reply mail responding to the scam mail (step S205), the mail control device 20 relays the reply mail (step S206). Thereby, the portable terminal 26 of the attacker 25 receives the reply mail, and acquires the confirmation code from the user 29 (step S207).

Thereafter, by using the acquired confirmation code, and by the personal computer 27, the attacker 25 takes steps for changing the identity information (the password) of the user 29 registered in the server 24 of the information system (step S208). In response to the steps, the server 24 changes the identity information of the user 29 to new identity information set by the attacker 25 (step S209). Thus, by using the illegally set identity information (password), the attacker 25 can impersonate the user 29 and exploit a service of the information system. Then, for example, when the attacker 25 requests the server 24 of the information system to transmit personal information (user information) of the user 29 (step S210), the server 24 transmits the personal information in response to the request (step S211). Thereby, the attacker 25 acquires the personal information of the user 29 through the personal computer 27 (step S212).

The mail control device 20 of the second example embodiment includes the detection unit 30, the suspension unit 31, the confirmation unit 32, and the cancellation unit 33, and thereby, can prevent a situation where the mail including the authentication-related information (the confirmation code) is transmitted from the portable terminal 28 of the user 29 and reaches the portable terminal 26 of the attacker 25. Thereby, the mail control device 20 can prevent the flow of the scam process as illustrated in FIG. 5, and can prevent the scam (including information leakage) using the function of changing the identity-information in the information system.

### Third Example Embodiment

Hereinafter, a third example embodiment according to the present invention is described. Note that in the description of the third example embodiment, the same reference symbols are given to the parts the names of which are the same as those of configuration parts constituting the mail control device and the like of the second example embodiment, and the overlapping description of the common parts is omitted.

A mail control device 20 of the third example embodiment differs from the second example embodiment in the configuration related to reception of a reply from the user 29 concerning an inquiry included in the confirmation mail sent from the confirmation unit 32. The other configuration in the mail control device 20 of the third example embodiment is similar to that of the mail control device 20 of the second example embodiment.

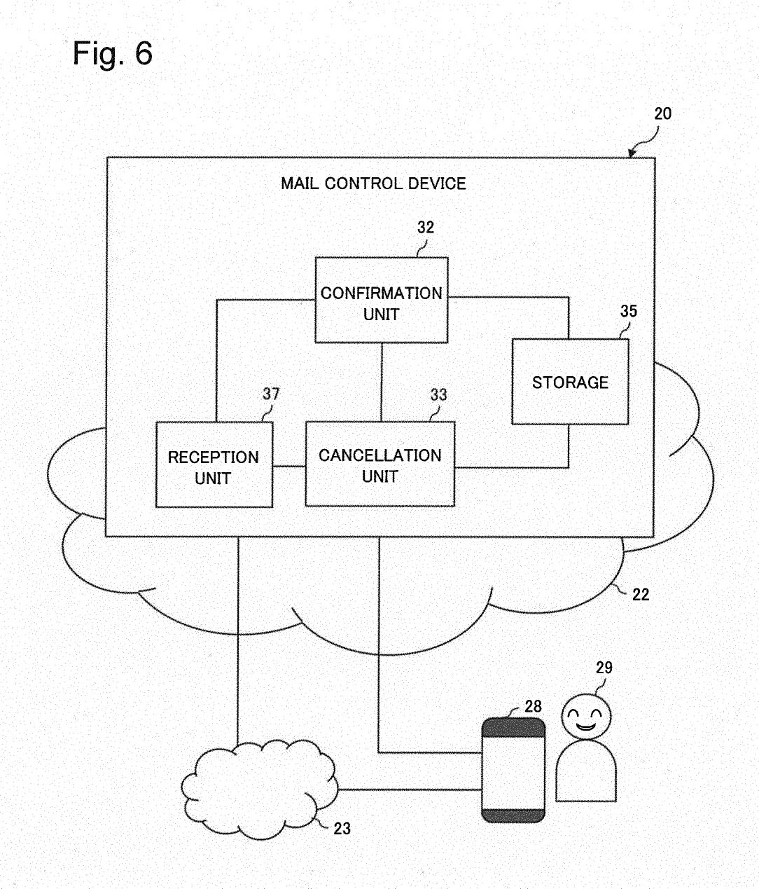

In other words, in the second example embodiment, by the reply mail responding to the confirmation mail, i.e., by using the mobile phone communication network 22, the mail control device 20 receives a reply concerning whether the pending mail needs to be transmitted (relayed). Meanwhile, in the third example embodiment, the mail control device 20 has a configuration of using the information communication network 23 such as the Internet, and thereby receiving a reply concerning whether the pending mail needs to be transmitted. In other words, the mail control device 20 includes a reception unit 37 as illustrated in FIG. 6. Note that in FIG. 6, configuration parts related mainly to the description of the third example embodiment are illustrated, and the illustration of the detection unit 30 and the suspension unit 31 constituting the mail control device 20 is omitted. The reception unit 37 is implemented by the CPU 7 similarly to the cancellation unit 33 and the like.

Further, in the third example embodiment, the confirmation mail transmitted by the confirmation unit 32 of the mail control device 20 to the portable terminal 28 of the user 29 includes a uniform resource locator (URL) of a website for receiving the reply to the inquiry of whether the pending mail needs to be transmitted. The reception unit 37 has a web interface function of receiving the reply from the user 29 that uses the web site for receiving the reply. When the reception unit 37 receives the reply requesting cancellation of transmission (relaying) of the pending mail, the cancellation unit 33 deletes the pending mail.

The mail control device 20 of the third example embodiment is configured as described above. Similarly to the second example embodiment, the mail control device 20 of the third example embodiment includes the detection unit 30, the suspension unit 31, the confirmation unit 32, and the cancellation unit 33, and thus, the advantageous effect similar to that in the second example embodiment can be accomplished. In other words, the mail control device 20 of the third example embodiment can also prevent the scam using the function of changing the identity-information in the information system.

### Fourth Example Embodiment

Hereinafter, a fourth example embodiment according to the present invention is described.

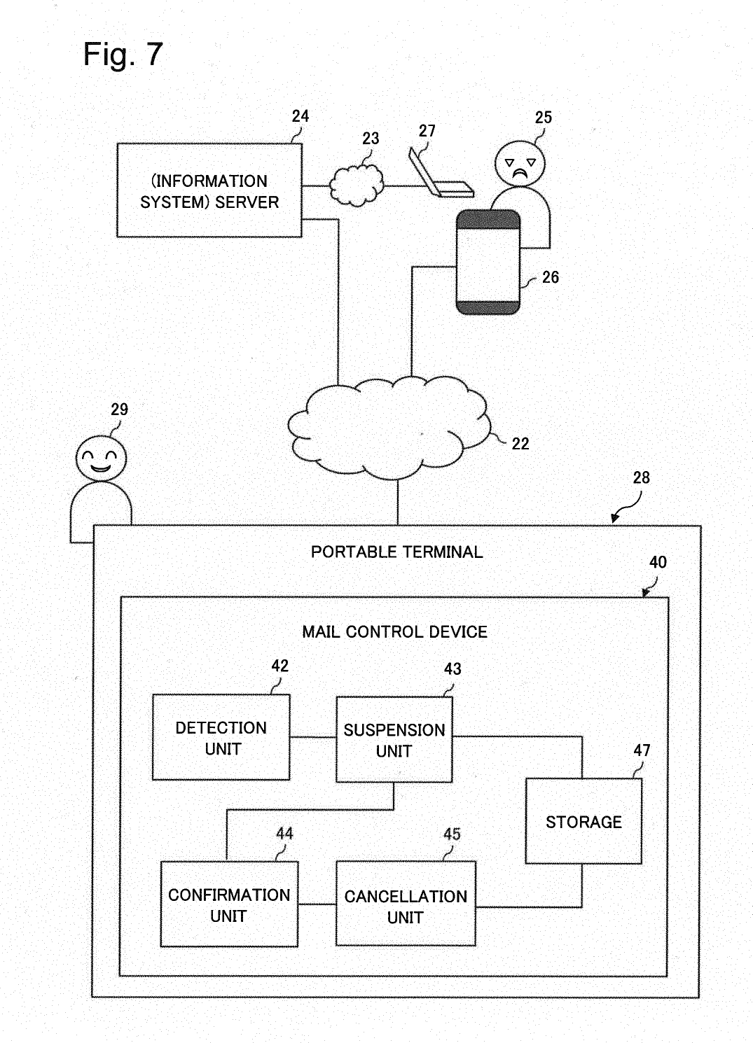

FIG. 7 is a diagram illustrating a configuration of a mail control device of the fourth example embodiment. The mail control device 40 of the fourth example embodiment is incorporated in a portable terminal (terminal device) 28 possessed by a user 29 of the information system to be protected. The portable terminal 28 includes an input device (operation keys and a touch panel) for inputting information. The portable terminal 28 further has a function of making mail, and a function of transmitting and receiving mail using the mobile phone communication network 22. Furthermore, the portable terminal 28 includes a display device (display) displaying information on a screen and a speaker generating sounds such as music and voices.

The mail control device 40 includes a detection unit 42, a suspension unit 43, a confirmation unit 44, a cancellation unit 45, and a storage 47. The storage 47 is implemented by the storage 8 and the memory 9 as illustrated in FIG. 2. Further, the detection unit 42, the suspension unit 43, the confirmation unit 44, and the cancellation unit 45 are implemented by the CPU 7 as illustrated in FIG. 2.

The detection unit 42 has a function of monitoring mail (SMS mail) received through the mobile phone communication network 22. Further, similarly to the detection unit 30 in the second and third example embodiments, the detection unit 42 has a function of detecting the secret mail (the mail including the authentication-related information (e.g., the confirmation code)) transmitted from the server 24 of the information system.

The suspension unit 43 has a function of, when the detection unit 42 detects the secret mail, monitoring SMS mail intended to be transmitted by the portable terminal 28, until a preset monitoring period (e.g., several hours) elapses from the time that the detection is made. Further, the suspension unit 43 has a function of, when detecting SMS mail including the same authentication-related information as the authentication-related information (a confirmation code) included in the secret mail, suspending transmission of the detected SMS mail. The suspended SMS mail (pending mail) is stored in the storage 47.

The confirmation unit 44 has a function of, when the suspension unit 43 suspends the SMS mail, displaying, to the user 29, on the display, a message to confirm whether the SMS mail needs to be transmitted, or notifying the message by a sound from a speaker.

The cancellation unit 45 has a function of deleting the pending mail from the storage 47 when detecting that the user responding to the message gives an instruction of cancelling the transmission of the pending mail by using the input device.

In the fourth example embodiment, the portable terminal 28 of the user 29 includes the incorporated mail control device 40, and thereby, can prevent a situation where the mail including the authentication-related information (the confirmation code) is transmitted from the portable terminal 28 of the user 29 to the attacker 25. Thus, the portable terminal 28 including the mail control device 40 can prevent the scam using the function of changing the identity-information (the password) in the information system.

### Other Example Embodiments

The present invention is not limited to the first to fourth example embodiments, and various example embodiments can be adopted. For example, in the second to fourth example embodiments, the secret mail for transmission of the authentication-related information (the confirmation code) from the server 24 of the information system to the user 29 is SMS mail. The scam mail and the reply mail responding to the scam mail is also SMS mail. Alternatively, the present invention can be applied also to the case where these pieces of mail are mail (e.g., carrier mail, or mail based on the multimedia messaging service (MMS) or the rich communication suite (RCS)) of a standard other than that of SMS mail.

For example, when these pieces of mail are mail of standards other than that of SMS mail, the mail control device 20 of the second and third example embodiments is incorporated in a server interposed in an information communication network having a function of relaying these pieces of mail, instead of being incorporated in the mobile phone communication network 22. In this case, the mail control device 20 has a configuration for which the standard of mail is taken into consideration. Further, the mail control device 40 in the portable terminal 28 of the user 29 may have a configuration for which the standard of mail is taken into consideration, as well.

The mail control device 40 in the portable terminal 28 can be applied also to the case where the secret mail is SMS mail and the scam mail is mail (e.g., mail via the information communication network 23 such as the Internet) of a standard other than that of SMS mail.

Further, in the second and third example embodiments, the mail control device 20 is incorporated in the server having the function of relaying mail. Alternatively, the mail control device 20 may be provided separately from the server having the mail relaying function. In this case, it is possible to achieve development of a configuration in which the mail control device 20 acquires, from the mobile phone communication network 22 and the information communication network 23, respectively, information related to mail, and prevents a situation where mail including the authentication-related information reaches the attacker 25, as in the second example embodiment.

Further, in the second to fourth example embodiments, the description is made above by citing a password as a specific example of information (the identity information) used in the authentication process of the information system, but the identity information is not limited to the password.

The present invention is described above by citing the above-described example embodiments as typical examples. However, the present invention is not limited to the above-described example embodiments. In other words, according to the present invention, various configurations that can be understood by those skilled in the art can be applied within the scope of the present invention.

The present patent application claims priority based on Japanese patent application No. 2015-251858 filed on Dec. 24, 2015, the disclosure of which is incorporated herein in its entirety.

### REFERENCE SIGNS LIST

1, 20, 40 Mail control device
3, 30, 42 Detection unit
4, 31, 43 Suspension unit
5, 32, 44 Confirmation unit
33, 45 Cancellation unit
37 Reception unit

1. A mail control device comprising
a processor configured to:
detect, as secret mail, mail that is sent from an information system to be protected, and includes authentication-related information related to information used in an authentication process of the information system;
monitor transmitted mail for a preset monitoring period from a time when the secret mail is detected, and, when detecting mail including the authentication-related information, suspend transmission of the detected mail; and
present, to a sender of a pending mail, a message to confirm whether it is necessary to transmit the pending mail, the pending mail being the mail suspended for transmission.

2. The mail control device according to claim 1, wherein the secret mail is mail based on a short message service, and an address of the mail is a mobile phone number.

3. The mail control device according to claim 1, wherein
the mail control device is interposed in a communication network and further including a function of relaying mail,
the processor detects the secret mail from mail to be relayed,
the processor monitors mail of which sender is a destination of the secret mail for the monitoring period, and when detecting mail including the authentication-related information from the monitored mail, suspends the detected mail, and
the processor transmits confirmation mail to a sender of the pending mail, the confirmation mail is mail including a message to confirm whether the pending mail needs to be transmitted.

4. The mail control device according to claim 3, wherein
the processor deletes the pending mail when mail returned in response to the confirmation mail includes an instruction of cancelling transmission of the pending mail.

5. The mail control device according to claim 3, wherein
the processor, by using a web user interface, receives a reply responding to a request that is made by the confirmation mail and is for confirming whether the pending mail needs to be transmitted; and
the processor deletes the pending mail when the received reply is an instruction of cancelling transmission of the pending mail.

6. The mail control device according to claim 1, wherein
the mail control device is incorporated in a terminal device provided with a function of generating, transmitting, and receiving mail,
the processor monitors mail to be transmitted, and when detecting mail including the authentication-related information, suspends transmission of the detected mail, and
the processor visually or auditorily notifies a message to a user who is a sender of the pending mail, the message is a message to confirm whether the pending mail needs to be transmitted.

7. The mail control device according to claim 6, wherein
the processor deletes the pending mail when an instruction to cancel transmission of the pending mail is inputted by using an input device inputting information, as a reply to a request for confirming whether the pending mail needs to be transmitted.

8. A mail control method comprising:
detecting, as secret mail, mail that is sent from an information system to be protected, and includes authentication-related information related to information used in an authentication process of the information system;
monitoring transmitted mail for a preset monitoring period from a time when the secret mail is detected, and, when detecting mail including the authentication-related information, suspending transmission of the detected mail; and
presenting, to a sender of a pending mail, a message to confirm whether it is necessary to transmit the pending mail, the pending mail being the mail suspended for transmission.

9. A non-transitory program storage medium that stores a computer program representing a control procedure causing a computer to perform:
detecting, as secret mail, mail that is sent from an information system to be protected, and includes authentication-related information related to information used in an authentication process of the information system;
monitoring transmitted mail for a preset monitoring period from a time when the secret mail is detected, and, when detecting mail including the authentication-related information, suspending transmission of the detected mail; and
presenting, to a sender of a pending mail, a message to confirm whether it is necessary to transmit the pending mail, the pending mail being the mail suspended for transmission.
